(19) United States
(12) Patent Application Publication
(10) Pub. No.: US 2023/0122297 A1
(43) Pub. Date: Apr. 20, 2023

(54) FOLDABLE GAMING CABINET

(71) Applicant: Elite Gaming Technology Inc., Bloomingdale, IL (US)

(72) Inventor: James Conlon, Bloomingdale, IL (US)

(21) Appl. No.: 17/504,027

(22) Filed: Oct. 18, 2021

(51) Int. Cl. G07F 17/32

(52) U.S. Cl. CPC G07F 17/3216; G07F 17/3211

(57) ABSTRACT

A gaming machine and method of using it are provided. The gaming machine includes mechanisms to reduce its height for purposes of easing shipping and maintenance. The gaming machine is moveable between and operating position and folded position wherein the height of the gaming machine is less when in the folded position facilitating shipping and standard shipping containers and easing access for subsequent maintenance.

### BACKGROUND OF THE INVENTION

The present invention relates to the construction and functionality of cabinets used in the gaming and amusement industries, referred to herein as gaining cabinets. Gaming cabinets are commonly used to house the electronics associated with a game including monitors that display graphics associated with game. As the popularity of electronic slot machines and other video amusement games has grown, the design and functionality of gaming cabinets has become more elaborate. Many gaining cabinets now house multiple screens and have grown in size. Some cabinets now exceeding eight feet tall. These changes have created many challenges in the manufacture, assembly and subsequent delivery and installation of the gaming cabinets. For example, many of the larger cabinets may require on site assembly or special shipping procedures because of their size. These issues add not only inconvenience but also cost for the ultimate customer.

In addition, in many locations gaming cabinets are placed in banks. It is desirable that when the gaming cabinets are placed in banks that they present uniformity in size and height. This presents a challenge for on-site assembly and installation of the cabinet.

As a result there is a need for a cabinet design the eases the burden of assembly, shipping and installation of the modern gaming cabinet.

### BRIEF SUMMARY OF THE INVENTION

Embodiments of the present disclosure include a gaining cabinet that has at least two configurations—a folded configuration and an operating configuration. One aspect of the invention is the gaming cabin can be easily moved from one configuration to another when installed at it final location. In one embodiment that present disclosure is directed to a gaming cabinet that incorporates at least two video monitors. The gaming cabinet includes an upper box and a lower box each adapted to hold a video monitor. The upper box is designed so that at least a portion of the upper box can be move from an operating position to a folded position with a height substantially lower than that of the cabinet in the operating configuration. In the folded configuration, the gaming cabinet assembly is shorter than when in the operating configuration, facilitating easier shipping with conventional shipping methods as well easing installation of the video monitor and associated electronic into the upper box.

In another embodiment the gaming cabinet preferably includes a resistance device to counterbalance the weight of the upper box and facilitate the movement from one configuration to another.

In yet another embodiment the gaming cabinet may include structure to hold the upper box in the operating position, the folded position or any position in between.

### BRIEF DESCRIPTION OF THE DRAWINGS

FIG. 1 is a perspective view of a typical gaming cabinet

FIG. 2 is a side view of an embodiment of the present disclosure in the operating configuration.

FIG. 3 is a side view of an embodiment of the present disclosure from FIG. 2 in the folded configuration.

FIG. 4 is a perspective view of an embodiment of the present disclosure from FIG. 2 in the folded configuration.

FIG. 5 is a detail of an embodiment of a top box of the present disclosure in the operating position.

FIG. 6 is a detail of an embodiment of a top box of the present disclosure in the folded position.

FIG. 7 is a side view of a second embodiment of the present disclosure on the operating configuration

FIG. 8 is a side view of embodiment of FIG. 7 in the folded configuration

### DETAILED DESCRIPTION OF THE INVENTION

The following detail description illustrates representative embodiments of the disclosure. It should be understood that the invention is not intended to be limited to the specific disclosure and would encompass variants that one skilled in the art would clearly understand in light of the disclosure.

Described is a gaming cabinet that can be used in conjunction with gambling and or amusement games. The described preferred embodiment comprises two video monitors, it should be understood however that the invention is equally applicable to gaming cabinets that have a single gaming screen or more than two screens.

The disclosure is described by reference to the drawings by way of illustration but not limitation. Described is a gaming cabinet that can be reduced in height to facilitate both shipping and assembly. In the inventive gaming cabinet the upper portion of the gaming cabinet can be lowered to a folded position. Once in the folded position access to the upper portion of the cabinet is more readily available allowing simpler assembly such as the installation of electronics including a video monitor. Moreover, the height of the gaming cabinet assembly is reduced which allows shipment with standard equipment and eliminates the need to employ specialty equipment such as high overhead trailers. In this way the disclosure reduces both the time and cost of assembly and shipping.

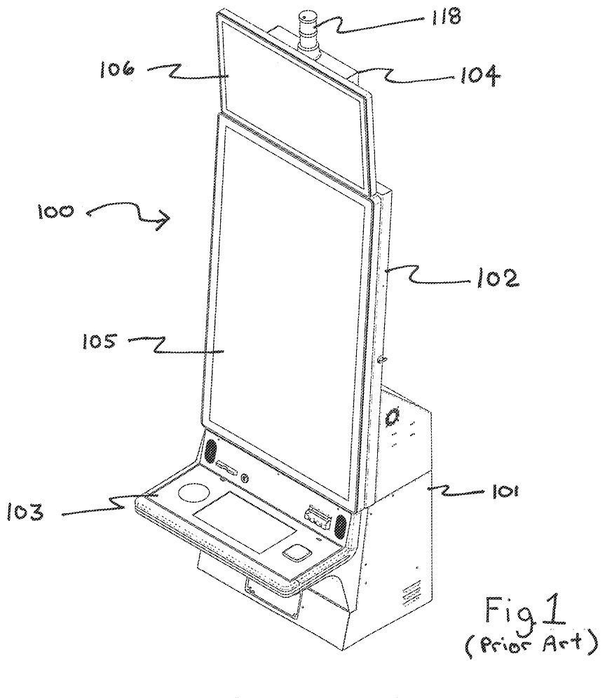

FIG. 1 shows a typical assembly of a gaming cabinet 100. The gaming cabinet 100 include a base 101, a first box or lower box 103 and a second box or upper box 104. The base 101 typically contains the principal electronics associated with the game. This may include such things as a CPU and money handling equipment for accepting money and dispensing winnings. In the amusement industry, often money is not directly involved and tickets or gaming cards may be used as substitutes. The base 101 is also typically adapted to include a button deck 103 where the user plays the game and interacts with the gaming machine.

The lower box 102 is designed to support a video monitor 105 and the associated electronics. It should be understood that the use of the term box herein is not intended to convey any specific construction. Indeed as used herein the term box can relate to any construction that would be known in the art that is intended to support the video monitor and house the related electronics. It should also be understood that while the lower box 102 is shown as being vertical with respect to the base 101, any appropriate orientation would be with the scope of the invention. In addition, the base 101 and the lower box 102 can be comprised of two or more units bound in a cooperative manner, or may comprise a single integral unit.

The upper box 104 is typically positioned above the lower box 102 and defines the top of the cabinet. The upper box 104 may be set up to support a second video monitor 106 or other lighting features. The screen and/or the lighting features may extend over the top of the cabinet, increasing the height. The upper box 104 also typically encases associated electronics, such as power cords and video feed cables to provide signals and power to the second video monitor 106 and any other lighting features. Such other lighting features will depend on the need of the particular game. For example, it may support a light or light array that interacts with the game. The light 118 shown in FIG. 1 is an example of such a lighting feature. In a typical prior art gaming cabinet, the upper box 104 is immovably attached to the lower box 102 either directly or indirectly. They can comprise separate component of the gaming cabinet 101 or may be single integral unit.

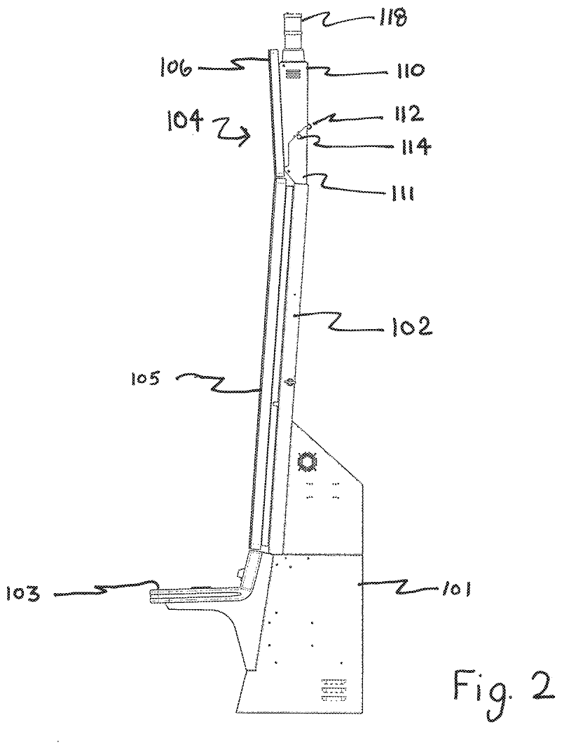

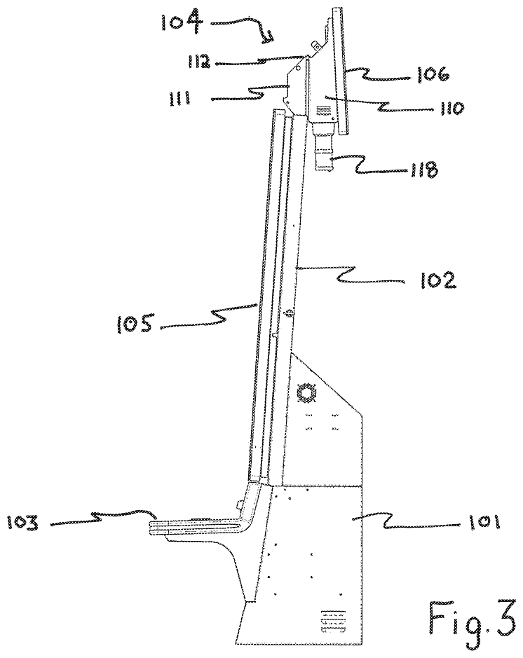

FIGS. 2 and 3 depicts a gaming cabinet 100 modified to incorporate the present disclosure. Specifically, FIG. 2 is a side view of an embodiment of the cabinet of the present disclosure in the operating configuration and FIG. 3 is a side view of an embodiment of the cabinet of the present disclosure in the folded configuration. In this embodiment of the disclosure a first or upper portion 110 of the upper box 104 is movable between the operating position and the folded position. When the upper box 104 is in the folded positioned the gaming cabinet assembly 100 has a height less than when in the operating position. It should be understood, the while in the present embodiment the upper box 104 comprises two portions, one skilled in the art would understand that in an alternative design the second or lower portion 111 of the upper box 104 could instead be associated with or integral to the lower box 102.

The movement can be accomplished by a number of different mechanisms. In one preferred embodiment a hinge or a plurality of hinges 112 are mounted on the upper portion 110 upper box 104 and the lower portion 111 of the upper box 104 to allow the upper box 104 to pivot with respect to the lower box 102. A preferred embodiment includes a resistive counterbalance mechanism to reduce the downward force caused by the weight of upper portion 110 of the upper box 104 when moving between the operating position and the folded position. An example of the resistive counterbalance is a friction hinge mechanism. The size and number of friction hinges appropriate will depend on the size and weight of the upper box. Other mechanism well known in the art, such resistive spring mechanisms or pneumatic cylinder mechanisms operatively attached to the upper box 104 could also be used. Examples of such mechanisms are disclosed in U.S. Pat. Nos. 6,019,332, 6,962,528, 10,445,973 and U.S. Application 2006/0287112 each of which is incorporated by reference herein. In addition, the cabinet of the present disclosure preferably includes a locking mechanism 114 to hold the cabinet in the operating configuration. In a preferred embodiment the locking mechanism is a pull pin assembly that is associated with the upper portion 110 of the upper box 104 and the lower portion 111 of the upper box 104 to hold the upper portion 110 of the upper box 104 in the operating position. An example of a pull pin assembly useful in the present disclosure is the PEM® PTL2 and PSL2 Spring-Loaded Plunger Assembly manufactured by PennEngineering. While a pull pin assembly is shown it should be understood that one skilled in the art would understand that other mechanisms could be used to the hold the cabinet in the operating configuration.

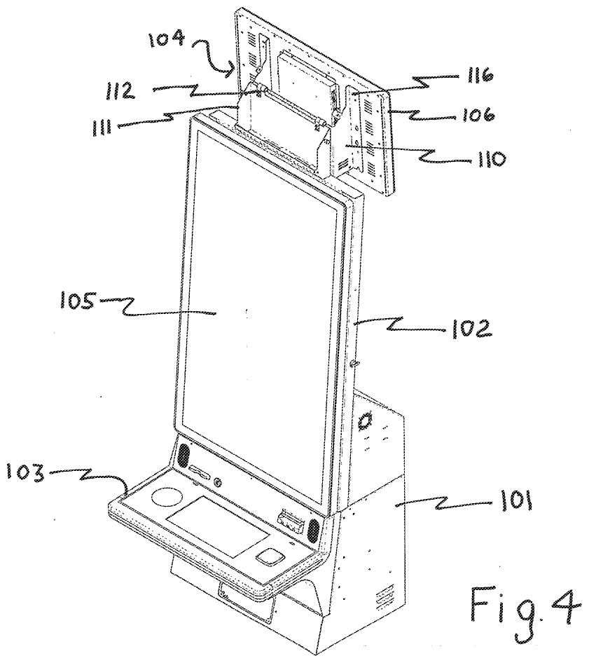

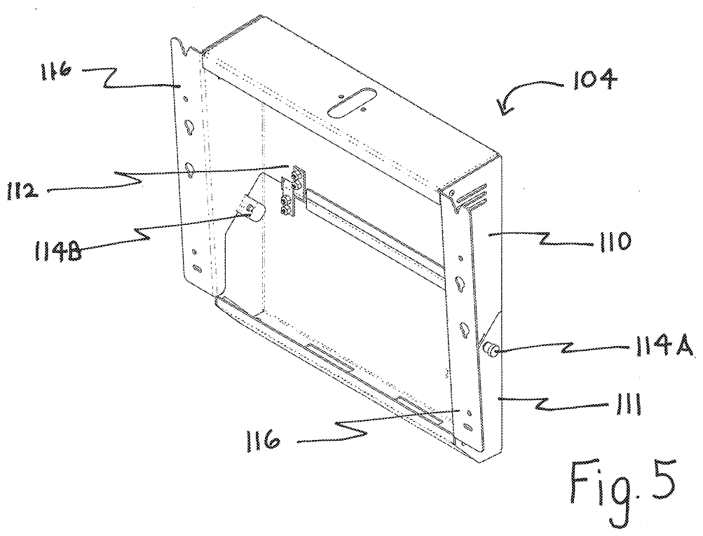

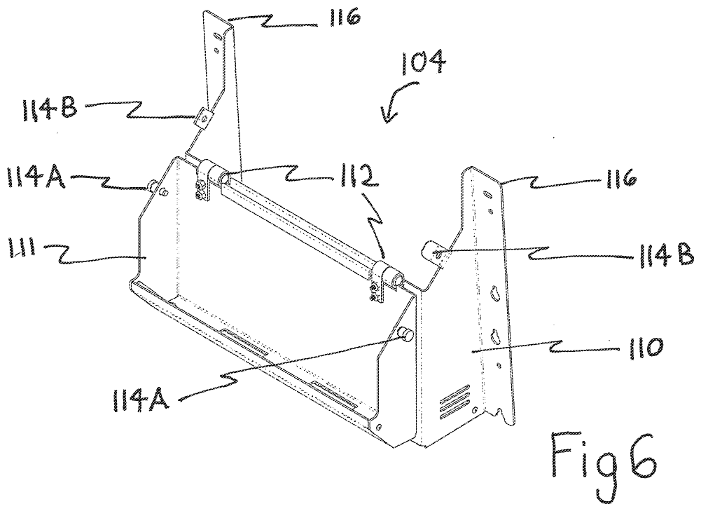

FIGS. 4, 5 and 6 provide additional detail on the function of the upper box 104 in the present disclosure. FIG. 4 shows perspective of an embodiment of the present disclosure in the folded configuration. FIGS. 5 and 6 show the structure of the upper box 10 in the operating position and the folded position respectively. From these drawings it can be seen that this embodiment of the upper box 104 includes two portions—the upper portion 110 and lower portion 111 that are rotationally attached to each other. The upper portion 110 includes flanges 116 that are adapted to attach the upper video monitor 106 to the upper box 104. The upper portion 110 and the lower portion 111 are attached to each other with friction hinges 112 that allows movement between the operating position (shown in FIG. 5) and the folded position (shown in FIGS. 4 and 6).

It is often important that the upper box 104 be able to be maintained in a uniform and consistent operating position. Gaming cabinets are often placed in banks of multiple cabinets. In order to present a unified appearance the operating position for each of the cabinets should be the same. Therefore, it can be important that the operating position should be consistent from cabinet to cabinet. FIGS. 5 and 6 illustrate the locking mechanism 114 of an embodiment of the disclosure to ensure that location of the upper box 104 in the operating position is uniform. Specifically, pull pins 114A are associated with an aperture in sides of the lower portion 111. The upper portion 110 includes a set of tabs 114B defining apertures positioned to engage with pull pins 114A when upper box is in the operating position (as shown in FIG. 5). When so engaged the upper box 104 is releasably locked in the operating position restricting movement to the folded position.

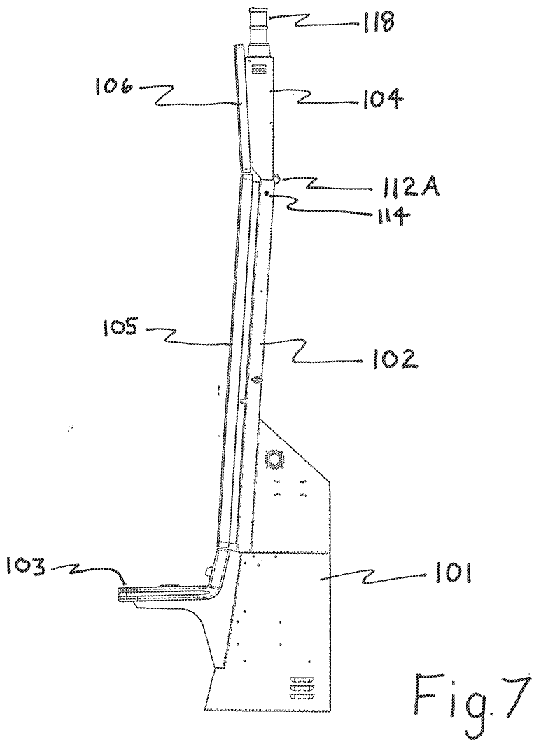

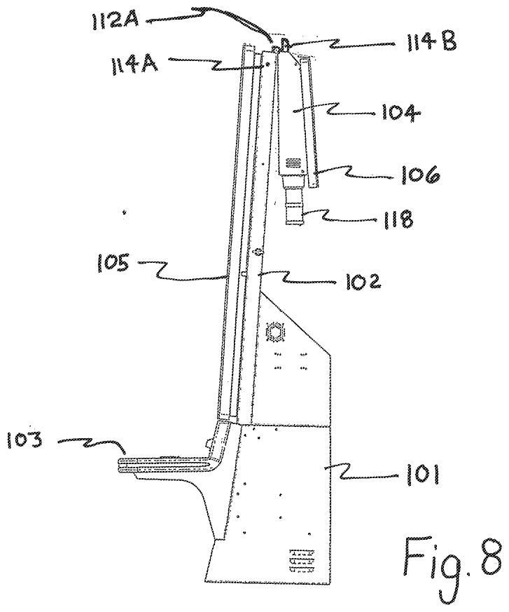

FIGS. 7 and 8 depict another embodiment of a gaming cabinet 100 modified to incorporate the present disclosure. In this embodiment of the disclosure the upper box 104 and the lower box 102 cooperate in manner where the entirety of the upper box 104 can be moved with respect to the lower box 102 from an operating position (FIG. 7) to a folded position (shown in FIG. 8) where the upper box 104 is positioned such that the gaming cabinet assembly 100 has a resultant height in the folded position substantially equal to the height of the lower box 102 when mounted on the base 101. In a preferred embodiment the upper box 104 is rotationally associated with the lower box 102 such that the upper box 104 in the folded position is substantially behind the lower box 102.

The movement can be accomplished by a number of different mechanisms. In one preferred embodiment a friction hinge or a plurality of friction hinges 112A are mounted on the upper box 104 and the lower box 102 to allow the upper box 104 to pivot with respect to the lower box 102. These friction hinges 112A are consistent with the friction hinges 112 shown in FIGS. 5 and 6 but are located in the position so as to rotationally cooperate with the lower box 102. The friction hinges 112A act as a resistive counterbalance mechanism to reduce the downward force caused by the weight of the upper box 104 when moving between the operating position and the folded position. Again, other resistive counterbalance could be employed including a spring mechanism associated with the hinge mechanism, a pneumatic cylinder mechanism operatively attached to the upper box 104 and the lower box 102, or similar mechanisms well known in the art. The resistive counter balance mechanism should be designed to support the upper box 104 and therefore will depend on the size and weight of the upper box 104.

In addition, this embodiment of the present disclosure includes a mechanism to hold the upper box 104 in the operating position. In a preferred embodiment a releasable pull pin 114A is associated with an opening defined by the lower box 102 and a tab 114B defined in second opening capable of engaging the pull pin 114A is associated with the upper box 104 in manner the when engaged the upper box 104 is fixed in the operating position. One skilled in the art would understand that arrangement of the these elements 114A and 114B could be reversed such that the pull pin 114A could be associated with an opening in the upper box 104 and the lower box would include a tab 114B to engage the pull pin 114A. It should be further noted that other mechanisms known in the art could be used, such as a cam/ratchet locking mechanism or a detent assembly, that cooperates with the upper box 104 and lower box 102 so as to prevent relative movement.

It will also be appreciated that it may be beneficial, to hold the upper box 104 in a position between the operating position and the folded position. This can be accomplished with appropriately sized friction hinges 112. Other mechanisms such as a cam lock associated with the hinge mechanism could also be employed. Such a mechanism may be useful for maintenance or repair of the electronics associates with the upper box 104.

I claim:

1. A gaming cabinet comprising:
(1) a first box; and
(2) a second box movably attached to the first box wherein the second box can move from an operating position substantially above the first box to a folded position wherein in the folded position a height of the gaming cabinet is less than a height of the gaming cabinet in the operating position.

2. The gaming cabinet of claim 1 wherein the first box is adapted to support a video monitor.

3. The gaming cabinet of game 1 wherein both the first box and the second box are adapted to support a video monitor.

4. The gaming cabinet of claim 1 further comprising a locking mechanism to releaseably hold the second box in the operating position.

5. The gaming cabinet of claim 4 wherein the locking mechanism is a pull pin mechanism.

6. The gaming cabinet of claim 1 further comprising a hinging assembly that allows the second box to move between the operating position and the folded position.

7. The gaming cabinet of claim 6 wherein the hinging assembly comprises at least one friction hinge.

8. The gaming cabinet of claim 1 further comprises counter balancing mechanism interacting between the second box and the first box to apply an upward force in a manner that reduces the force necessary to support the second box during movement between the operating position and the folded position.

9. A gaming cabinet comprising a box defining the top of the gaming cabinet, said box having a first portion and a second portion wherein the first portion is moveably attached to the second portion to be moveable between an operating position and folded position so that when in the folded position a height of the cabinet is less than a height of the gaming cabinet when in the operating position.

10. The gaming cabinet of claim 9 wherein the box is adapted to support a video monitor.

11. The gaming cabinet of claim 1 further comprising a locking mechanism to releaseably hold the first portion and the second portion of the box in the operating position.

12. The gaming cabinet of claim 11 wherein the locking mechanism is a pull pin mechanism.

13. The gaming cabinet of claim 9 further comprising a hinging assembly that allows the first portions and the second portion of the box to move between the operating position and the folded position.

14. The gaming cabinet of claim 13 wherein the hinging assembly comprises at least one friction hinge.

15. The gaming cabinet of claim 9 further comprises counter balancing mechanism interacting between the first portion and the second portion of the box so as to apply an upward force in a manner that reduces the force necessary to support the weight of the portion of the box moving between the operating position and the folded position.

16. A method of preparing a gaming cabinet for shipping comprising the steps of:
(1) providing a gaming cabinet that comprises a box that defines the top of the gaming cabinet, said box having a first portion and a second portion wherein the first portion is above the second portion and is moveably attached to the second portion to be moveable between an operating position and folded; and
(2) moving the first portion of the box into the folded position so that when in the folded position the height of the gaming cabinet is less than the height of gaming cabinet when in the operating position.

17. The method of claim 16 wherein the first portion of the box is in the operating position before it is moved to the folded position.

18. The method of claim 16 further comprising the step of releasing a locking mechanism before moving the first portion from the operating position to the folded position.
